(19) United States
(12) Patent Application Publication
(10) Pub. No.: US 2008/0292790 A1
(43) Pub. Date: Nov. 27, 2008

(54) Process For Producing a Coating Based on an Oxide Ceramic that Conforms to the Geometry of a Substrate Having Features in Relief

(75) Inventors: Severine Lebrette, Tours (FR); Philippe Boy, Joue Les Tours (FR); Philippe Belleville, Tours (FR); Yves Montouillout, Le Bardon (FR)

Correspondence Address: BRINKS, HOFER, GILSON & LIONE, 2801 SLATER ROAD, SUITE 120, MORRISVILLE, NC, 27560, US

(73) Assignee: COMMISSARIAT A L'ENERGIE ATOMIQUE, Paris (FR)

(21) Appl. No.: 12/094,631

(22) PCT Filed: Nov. 22, 2006
(86) PCT No.: PCT/EP06/68767

§ 371 Date: May 22, 2008

(30) Foreign Application Priority Data
Nov. 23, 2005 (FR) 05 53554

(51) Int. Cl. B05D 3/10

(52) U.S. Cl. 427/226

(57) ABSTRACT

The invention relates to a process for producing layers made of oxide ceramic that conform to substrates having features in relief comprising:
a step of depositing on said substrate a layer of a sol-gel solution that is a precursor of said ceramic;
a heat treatment step of said layer with a view to converting it to the ceramic;
   said steps being optionally repeated one or more times, characterized in that the sol-gel solution that is a precursor of said ceramic is prepared by a process successively comprising the following steps:
a) preparing a first solution by bringing the molecular precursor or precursors of the metals intended to be incorporated into the composition of the ceramic into contact with a medium comprising a diol solvent and optionally an aliphatic monoalcohol;
b) leaving the solution obtained in a) to stand for a sufficient time needed to obtain a solution that has a substantially constant viscosity;
c) diluting the solution obtained in b) to a predetermined amount with a dial solvent optionally identical to that from step a) or a solvent that is miscible with the dial solvent used in step a).

### TECHNICAL FIELD

The subject of the present invention is a process for producing a coating based on an oxide ceramic that conforms to the geometry of a substrate having features in relief, in particular features of micron-scale size.

The general technical field of the invention may therefore be defined as that of ceramic coatings for a substrate.

The coatings have, for example, the role of modifying the properties of a substrate, such as the mechanical properties, the thermal properties, the electrical properties and the chemical properties and optical properties.

The substrate coatings therefore find their application in numerous fields such as the fields of micro-electronics, optics or else energy.

Thus, in the field of microelectronics, the tendency is to move towards systems of increasingly reduced size, involving the use of structures in relief to increase, in particular, the active surface of these structures. The production of such structures requires knowing how to coat them with thin ceramic films, that generally have dielectric properties.

In the field of energy, in particular that of fuel cells, the tendency is to move towards portable systems, the size of which is a few millimetres and that comprise components whose critical dimensions are around 0.1 to 10 μm. Their manufacture requires the production of coatings on substrates of complex geometry, such as coatings made of LiCoO₂ that act as a cathode.

Finally, in the field of optics, in particular in photonic systems, the tendency is also towards miniaturization, especially of diffraction gratings. These diffraction gratings are generally, in photonic systems, in the form of tunnels that have features of micron-scale size on their surface. The production of ceramic coatings on these systems generally helps to provide these optical systems with better resistance.

Whether they are in the field of microelectronics, energy or optics, the ceramic coatings must have a uniform thickness over the substrates onto which they are deposited, this being in order to ensure a uniformity of the properties provided by these coatings.

The processes for depositing an oxide coating may be divided into two categories: namely, on the one hand, dry route processes and, on the other hand, wet route processes.

For dry route processes, the following are mainly distinguished in the literature, for depositing coatings on substrates having micron-scale features: chemical vapour deposition (known by the abbreviation CVD) and physical vapour deposition (known by the abbreviation PVD), one specific variant of which is ion implantation.

Chemical vapour deposition is a method in which the volatile compounds of the material to be deposited are converted to reactive species, such as radicals generated by microwaves, by plasma torches, etc., thus forming a vapour phase which reacts with the heated substrate to give a coating. The volatile compounds of the material to be deposited are optionally diluted in a carrier gas, such as hydrogen. This method has a certain number of advantages, among which mention may be made of good selectivity of the depositions, good adaptability in production lines. However, this method has the following drawbacks:
the coatings obtained are not very dense;
they are often contaminated by very reactive gases derived from the chemical reaction (hydrogen, halogens);
they have a poor adhesion to the substrate; and
the coatings have poor acuity at the edges of the features in relief.

One more advantageous method may consist in carrying out the coatings by physical vapour deposition, such as evaporation, spray coating and ablation. For example, evaporation simply consists in evaporating or subliming the material to be deposited in a crucible under vacuum by heating it at high temperature. The material evaporated is deposited by condensation onto the substrate to be covered and a layer is formed on the substrate. Although this method makes it possible to obtain denser layers, this method has proved to be difficult to implement, due to the equipment to be used, and costly, and does not ensure a uniform thickness of the layers on the substrates having features in relief.

In summary, whether it is by CVD or PVD, the coatings on the substrates having features of micron-scale size obtained by these techniques do not have a uniform thickness over the entire deposition length and have, in particular, overthicknesses at the edges of the features in relief. This may cause, when the substrates thus coated are intended to be used as electronic components, variations in capacitance and also risks of breakdown at the edges of the features in relief.

Some authors have used the sol-gel process to form deposition solutions for substrates that have features in relief (Journal of the European Ceramic Society, 1998, 18(3), p. 255-260 [1]; Journal of Materials Research, 2003, 18(5); p. 1259-1265 [2]). However, in these documents it is a question of producing mouldings (that is to say the negative imprint) of the substrate and in no case of producing a coating of uniform thickness that matches the shape of the substrate.

There is thus a real need concerning a process for producing a coating that conforms to the geometry of a substrate having features in relief, which does not have the drawbacks encountered in the prior art with the dry route techniques.

### SUMMARY OF THE INVENTION

The objective of the invention is achieved by a process for producing a coating made of oxide ceramic that conforms to the geometry of a substrate having features in relief comprising:
a step of depositing on said substrate a layer of a sol-gel solution that is a precursor of said ceramic;
a heat treatment step of said layer with a view to converting it to said ceramic;
   said steps being optionally repeated one or more times, characterized in that the sol-gel solution that is a precursor of said ceramic is prepared by a process successively comprising the following steps:
   a) preparing a first solution by bringing the molecular precursor or precursors of metals and/or metalloids intended to be incorporated into the composition of the ceramic into contact with a medium comprising a solvent that comprises at least two —OH functional groups and optionally an aliphatic monoalcohol;
   b) leaving the solution obtained in a) to stand for a sufficient time needed to obtain a solution that has a substantially constant viscosity;
   c) diluting the solution obtained in b) to a predetermined amount with a solvent identical to that from step a) or a solvent that is miscible with the solvent used in step a) but different from it.

According to the invention, the term “miscible solvent” is understood to mean a solvent which may be mixed with the solvent comprising at least two —OH functional groups and where appropriate with the aliphatic mono-alcohol, forming a homogeneous mixture, this being in any proportions at ambient temperature, that is to say at a temperature of the surrounding atmosphere generally between 20 and 25° C.

The process of the invention, using sol-gel technology to form the deposition solution, has the following advantages:
it makes it possible to produce coatings on complex surfaces of diverse sizes and without requiring heavy-duty equipment;
it makes it possible to obtain depositions that are homogeneous in composition; and
due to the fact that the mixing of the species takes place at the molecular level, it is possible to easily produce, via this process, complex oxides comprising, for example, three or more elements and to control the stoichiometry.

Furthermore, the process of the invention advantageously makes it possible to obtain coatings that conform to the geometry of the substrate, that is to say coatings that have a substantially uniform thickness over the entire deposition length owing, in particular, to the stability properties of the sol-gel solution obtained prior to the deposition.

According to the invention, the oxide ceramics that form the coating may be chosen from oxides having a perovskite structure such as from lead zirconium titanate (known by the abbreviation PZT), barium titanate, barium strontium titanate (known by the abbreviation BST), lead zinc niobium titanate (known by the abbreviation PZNT), lead zinc niobate (known by the abbreviation PZN), lead magnesium niobate (known by the abbreviation PMN), lead titanate (known by the abbreviation PT), potassium calcium niobate, bismuth potassium titanate (known by the abbreviation BKT), strontium bismuth titanate (known by the abbreviation SBT), potassium tantalate (known by the abbreviation KLT) and solid solutions of PMN and PT.

The oxide ceramics that form the coating may also be chosen from simple oxides such as SiO₂, HfO₂, ZrO₂, Al₂O₃ and Ta₂O₅.

Thus, the process of the invention comprises the preparation of a stable sol-gel solution. This preparation firstly comprises bringing one or more metal and/or metalloid molecular precursors to be incorporated into the composition of the ceramic into contact with a medium comprising a solvent that comprises at least two —OH functional groups and optionally an aliphatic monoalcohol.

The metal may be chosen from a group composed of alkali metals, such as K, alkaline-earth metals, such as Mg, transition metals, lanthanide metals and metals known as post-transition metals from columns IIIA and IVA from the Periodic Table of Elements. The transition metals may be chosen from Ti, V, Cr, Mn, Fe, Co, Ni, Cu, Zn, Y, Zr, Nb, Mo, Ru, Rh, Pd, Ag, Cd, Hf, Ta, W, Re, Os, Ir, Pt. The lanthanide metals may be chosen from La, Ce, Pr, Nd, Sm, Eu, Gd, Tb, Dy, Er, Yb. The post-transition metals may be chosen from the group IIIA elements: Al, Ga, In and Tl and the group IVA elements: Ge, Sn and Pb.

The metalloids may be chosen from Si, Se and Te.

The metal and/or metalloid molecular precursors may be in the form of inorganic metal or metalloid salts such as halides (fluorides, chlorides, bromides or iodides), nitrates or oxalates.

The metal and/or metalloid molecular precursors may also be in the form of organometallic metal or metalloid compounds, such as alkoxides corresponding to the formula (RO)ₙM, in which M denotes the metal or metalloid, n represents the number of ligands linked to M, this number also corresponding to the valency of M, and R represents a linear or branched alkyl group which may comprise from 1 to 10 carbon atoms or an aromatic group comprising from 4 to 14 carbon atoms, such as a phenyl group.

The metal or metalloid molecular precursors may also be in the form of organometallic compounds of formula:

X_{y}R¹_{z}M

in which:
M represents a metal or a metalloid;
X represents a hydrolysable group chosen from halogen, acrylate, acetoxy, acyl or OR′ groups, with R′ representing a linear or branched alkyl group which may comprise from 1 to 10 carbon atoms or an aromatic group comprising from 4 to 14 carbon atoms, such as a phenyl group;
R¹ represents a non-hydrolysable group chosen from optionally perfluorinated linear or branched alkyl groups which may comprise from 1 to 10 carbon atoms, or aromatic groups which may comprise from 4 to 14 carbon atoms; and
y and z are integers chosen so that y+z is equal to the valency M.

In addition to the aforementioned molecular precursors, the first solution from step a) may additionally contain one or more polymerizable compounds, such as ethylenic monomers, for instance styrene.

Thus, when the coating that it is desired to produce is a PZT coating, the molecular precursors to be used for preparing sol-gel solutions are respectively lead-containing molecular precursors, zirconium-containing molecular precursors and titanium-containing molecular precursors.

By way of example, it is possible to use, as a lead-containing precursor, organic lead salts such as acetates, inorganic lead salts such as chlorides or else organometallic lead compounds such as alcoholates that comprise a number of carbon atoms ranging from 1 to 4. Preferably, the lead-containing precursor used is a hydrated organic salt such as lead acetate trihydrate. This precursor has the advantage of being stable, very common and inexpensive. However, during the use of such a hydrated precursor, it is preferable to carry out a dehydration of the latter. This is because the presence of water during the mixing together of the sol-gel solutions may lead to a premature hydrolysis of the metallic precursors followed by a polymerization and therefore a sol-gel solution that is unstable over time.

For example, the dehydration of lead acetate trihydrate may be carried out by distillation of the latter in the solvent comprising at least two —OH functional groups used to carry out the mixing of the sol-gel solutions.

Preferably, the titanium-containing precursors are alkoxides, such as titanium isopropoxide. Similarly, the zirconium-containing precursors are preferably alkoxides, such as zirconium n-propoxide.

When the coating that it is desired to obtain is a BST coating, the molecular precursors to be used for preparing the sol-gel solution are respectively barium-containing molecular precursors, strontium-containing molecular precursors and titanium-containing molecular precursors.

When the coating that it is desired to obtain is a PZNT coating, the molecular precursors to be used for preparing the sol-gel solution are respectively lead-containing molecular precursors, zirconium-containing molecular precursors, niobium-containing molecular precursors and titanium-containing molecular precursors.

When the coating that it is desired to obtain is a PMN coating, the molecular precursors to be used for preparing the sol-gel solution are respectively lead-containing molecular precursors, magnesium-containing molecular precursors and niobium-containing molecular precursors.

When the coating that it is desired to obtain is a PT coating, the molecular precursors to be used for preparing the sol-gel solution are respectively lead-containing molecular precursors and titanium-containing molecular precursors.

When the coating that it is desired to obtain is a BKT coating, the molecular precursors to be used for preparing the sol-gel solution are respectively bismuth-containing molecular precursors, potassium-containing molecular precursors and titanium-containing molecular precursors.

When the coating that it is desired to obtain is an SBT coating, the molecular precursors to be used for preparing the sol-gel solution are respectively strontium-containing molecular precursors, bismuth-containing molecular precursors and titanium-containing molecular precursors.

When the coating that it is desired to obtain is a coating made of SiO₂, HfO₂, Ta₂O₅, ZrO₂ or Al₂O₃, the molecular precursors to be used for preparing the sol-gel solution are respectively silicon-containing, hafnium-containing, tantalum-containing, zirconium-containing or aluminium-containing molecular precursors.

The precursors such as mentioned above are brought into contact with a medium comprising a solvent that comprises at least two —OH functional groups and optionally an aliphatic monoalcohol.

The solvent comprising at least two —OH functional groups used in step a) and optionally c) may be an alkylene glycol having a number of carbon atoms that ranges from 2 to 5. This type of solvent helps to facilitate the solubilization of the precursors and, in addition, acts as an agent for stabilizing the sol-gel solution. A solvent comprising at least two —OH functional groups which may be used is ethylene glycol or else diethanolamine.

In addition to the solvent comprising at least two —OH functional groups, the medium from step a) may also comprise an aliphatic monoalcohol which may, for example, comprise from 1 to 6 carbon atoms. An aliphatic monoalcohol comprising from 1 to 6 carbon atoms may also be used as a dilution solvent in step c). By way of example of an aliphatic monoalcohol, mention may be made of n-propanol.

Bringing molecular precursors into contact with the medium comprising a solvent that comprises at least two —OH functional groups may be carried out in various ways and will depend on the nature of the precursors, the main thing being to obtain a sol-gel solution of homogeneous appearance.

For example, when the sol-gel solution is a precursor of a PZT ceramic, the contacting step may consist in preparing a first lead-based sol-gel solution in a diol solvent, by dissolving a lead-based molecular precursor in this diol solvent, to which is added a second mixed sol-gel solution based on titanium and on zirconium, said mixed sol-gel solution possibly being prepared by dissolving a zirconium-based molecular precursor and a titanium-based molecular precursor in the same diol or in a solvent that is compatible with said diol, namely a solvent that is miscible with said diol, as is the case for aliphatic monoalcohols such as propanol. It is specified that the lead-based sol-gel solution is preferably initially in an excess of 10% relative to the stoichiometry. The mixture of said sol-gel solutions may then be refluxed, with stirring, at a temperature that approaches the boiling point of the reaction mixture. Refluxing makes it possible to ensure, advantageously, a homogenization of the sol-gel solutions mixed together.

Once the sol-gel solution is obtained at the end of step a), the sol-gel solution is left to stand, according to the invention, for a sufficient time to obtain a solution that has a substantially constant viscosity. Generally, step b) is preferably carried out at ambient temperature, for example, for a duration which may stretch from one week to 4 months. During this maturing phase, the dissolved metal and/or metalloid precursors condense to an equilibrium state. This condensation is expressed by an increase in the viscosity of the sol-gel solution, until a value that is substantially constant as a function of time is achieved, when the equilibrium state is reached. In practice, the solution prepared in a) is left to stand, generally, at ambient temperature and in the absence of any heating. At the same time, the viscosity of the solution is measured at regular intervals. Once this has a substantially constant viscosity, generally reached at the end of a period ranging from 1 week to 4 months, the solution is diluted to a predetermined dilution level (step c). This dilution level will be chosen by a person skilled in the art according to the envisaged use of the sol-gel solution, and especially according to the desired coating thickness after deposition and treatment of such a solution on a substrate and also according to the deposition technique.

This dilution may consist in diluting the sol-gel solution obtained at the end of step b) by a dilution factor ranging from 1 to 20.

According to the invention, the dilution solvent must be miscible with the solvent for preparing the solution from step a). It may be identical to the solvent that comprises at least two —OH functional groups for preparing the sol-gel solution from step a) or be another solvent that comprises at least two —OH functional groups. This alternative, consisting in using a solvent that comprises at least two —OH functional groups that is identical or different to that used within the context of step a), is especially chosen, preferably, when the deposition technique is spin coating. Examples of solvents that comprise at least two —OH functional groups that can be envisaged are ethylene glycol and propylene glycol.

The solvent may be different from a solvent used in step a) and chosen, for example, from solvents having a lower viscosity than that of the solvent used in step a). Solvents corresponding to this specification are, for example, aliphatic monoalcohols comprising from 1 to 6 carbon atoms such as defined above. In particular, it is advantageous to use, as a dilution solvent, a solvent that has a lower viscosity than that of the solvent used in step a), in order to obtain conformal coatings when the deposition technique used is dip coating.

Once prepared, the sol-gel solution is deposited on a substrate in the form of a layer.

This deposition may be carried out by any technique that makes it possible to obtain a deposition in the form of thin layers. The thicknesses of the thin layers deposited according to the invention may range from 1 to 500 nm.

The deposition may be carried out according to one of the following techniques:
dip coating;
spin coating;
laminar-flow coating (otherwise known as meniscus coating); and
spray coating.

However, the deposition will preferably be carried out by the technique of dip coating or else by the technique of spin coating. These techniques in particular make it easier to achieve precise control of the thicknesses of layers deposited.

As regards the technique of dip coating, the substrate is immersed in the previously prepared sol-gel solution, then withdrawn at a suitable speed to obtain a conformal deposition, such as defined above. The advantage of this technique is that several substrates can be treated at the same time, which allows a gain in productivity.

As regards the technique of spin coating, the substrate intended to be coated is placed on a rotating support. Next, a volume of sol-gel solution allowing said substrate to be covered is deposited. The centrifugal force spreads said solution in the form of a thin layer. The thickness of the layer is in particular dependent on the centrifugation speed and on the concentration of the solution. Since the solution concentration parameter is fixed, the person skilled in the art may readily choose a centrifugation speed suitable for a desired layer thickness. As mentioned above, in the case of the use of the spin-coating technique, the dilution solvent used in step c) will preferably be a solvent that comprises at least two —OH functional groups that is identical to that used in step a) or optionally another solvent that comprises at least two —OH functional groups.

According to the invention, the substrate intended to be coated is a substrate comprising features in relief, for example of micro-scale size. It is specified that the expression “features of micron-scale size” is understood, generally, to mean features in relief that have dimensions (such as height, width) that range from 1 to 100 μm, these features being also spaced apart by a distance that ranges from 1 to 100 μm.

These features in relief may especially be in the form of trenches, for example of parallelepipedal shape, having, for example, a depth, a height and a spacing of micron-scale size. This substrate may be in the form of a silicon wafer, optionally covered by a metallization layer, when the field of application is micro-electronics.

Once the sol-gel solution has been deposited on one side of the substrate, the process of the invention comprises a heat treatment of the deposited layer or layers, so as to convert them to the desired ceramic. This heat treatment may take place in various ways, depending on whether the process of the invention comprises the deposition of one or more layers.

Generally, this heat treatment comprises:
a step of drying each deposited layer, so as to gel the layer and optionally eliminate some of the solvent;
optionally, a step of pyrolysis of each deposited layer, so as to eliminate the organic compounds from the layer;
optionally, a step of relaxing each deposited layer, so as to eliminate the stresses generated during the shrinkage of the layer; and
optionally, a step of densifying the deposited layer or all of the deposited layers.

The heat treatment may be limited to a single drying step, if this suffices to obtain ceramization of the layer. This is especially the case for layers made of a simple oxide, such as SiO₂, HfO₂, Ta₂O₅, ZrO₂ or Al₂O₃.

For layers based on oxides of perovskite structure, the heat treatment generally requires a drying step, a pyrolysis step, a relaxation step and a densification step.

Thus, each deposited layer of solution undergoes, according to the invention, a step consisting of a step of drying the deposited layer so as to ensure gelling of the layer. This step is intended to ensure the evaporation of some of the solvent from step a) and some of the dilution solvent and optionally by-products such as esters, derived from reactions between the metallic precursors. At the end of this step, the sol-gel solution deposited is converted to a gel layer of constant thickness that adheres to the surface of the substrate. The effective temperature and duration in order to ensure gelling may be easily determined by a person skilled in the art using, for example, UV/visible spectrometry techniques.

For example, the drying step according to the invention may be carried out at ambient temperature for a duration ranging from 1 to 10 minutes. In other words, this deposition step will consist in letting the layer stand for a suitable duration, just after being deposited, so that it dries. This drying step may also be carried out at a temperature ranging from 40 to 80° C., for example, by using a hotplate. In this case, this step will be qualified, in the experimental part, as a pre-pyrolysis step.

After drying, each layer generally undergoes a pyrolysis step carried out at a temperature and for a duration that are effective for completely eliminating organic compounds from the deposited layer and in particular the solvents for preparing and diluting the sol-gel solution and the compounds generated by the reaction of the molecular precursors with each other. The effective temperature and duration may be determined easily by a person skilled in the art due to techniques such as IR (infrared) spectroscopy.

The pyrolysis time, for a given temperature, corresponds to a time that makes it possible to obtain a constant layer thickness. The layer thickness is controlled, for example, by profilometry techniques. The pyrolysis step is stopped upon obtaining a layer of uniform thickness free of organic compounds.

For example, when the deposited layer (or all of the deposited layers) is a precursor of a PZT ceramic, this pyrolysis step may be carried out at a temperature ranging from around 300 to around 400° C., preferably between 350 and 370° C., and for a duration ranging from around 5 minutes to 10 minutes.

After the pyrolysis step, each deposited layer may be made to undergo a relaxation step, in order to release the stresses generated during the shrinkage of the layer, in particular those accumulated at the features in relief. It is specified that the term “shrinkage” is understood to mean the decrease in the dimensions of the deposited layer, after drying and optional pyrolysis of this layer. This step may be carried out by keeping the deposited layer at a temperature slightly above, for example 10 to 30° C. above, the pyrolysis temperature, for a duration which may range from 10 to 30 minutes.

For example, when the layer is a precursor of a PZT ceramic, the relaxation temperature is 10 to 30° C. above the pyrolysis temperature but, preferably, must not exceed 400° C., so as to prevent the formation of a pyrochlore phase.

Finally, the deposited layer or all of the deposited layers may be subjected to a densification (or annealing) step for a duration and at a temperature that are effective for allowing the crystallization of the deposited layer or of all of the deposited layers. The crystallization of the layer corresponds to obtaining a layer of stabilized thickness and of crystalline structure, of perovskite type. The annealing temperature and duration are chosen so as to obtain this crystallization, that can be easily verified by structural analysis, such as analysis by X-ray diffraction.

Preferably, the densification is carried out at a temperature ranging from around 500 to around 800° C. for a duration between around 30 seconds and around 1 hour, in particular from 1 minute to 10 minutes.

The annealing may be carried out by various techniques. Preferably, the annealing is carried out by a rapid heating method obtained, for example, by the RTA (Rapid Thermal Annealing) technique or the RTP (Rapid Thermal Process) technique.

After this heat treatment, the thermal layers are homogeneous, continuous, conform to the geometry of the substrate and strongly adhere to the substrate.

The conformity factor, defined by the ratio of the thicknesses at the base of the features and at the peak or on the sides of the features is close to 1. This result, added to the simplicity of using the sol-gel technique, its cost and its gain in productivity bodes well for the use of such a process in an industrial setting.

The steps of depositing the sol-gel solution and of heat treatment may be repeated one or more times, until a coating having the desired thickness, for example a thickness ranging from 30 to 200 nm, is obtained.

This coating process finds an application, in particular, for producing electronic components, such as capacitors which may range from 100 nF/mm² to 1 μF/mm².

The invention will now be described relative to the following examples that are given by way of illustration and non-limitingly.

### BRIEF DESCRIPTION OF THE DRAWINGS

The single FIGURE illustrates a transverse cut through one part of a substrate that has features in the form of trenches equipped with a coating and that illustrates the dimensions necessary for determining conformity factors.

### DETAILED SUMMARY OF PARTICULAR EMBODIMENTS

The examples which follow firstly illustrate the preparation of sol-gel solutions used for producing conformal coatings, then secondly the production of conformal coatings on substrates having features in relief in the form of trenches.

The conformity of the coating relative to the geometry of the substrate is determined by the conformity factors (b/a) and (b/c), for which:
a corresponds to the thickness of the coating at the top of the trench;
b corresponds to the thickness of the coating at the bottom of the trench; and
c corresponds to the thickness of the coating at mid-height on the side of the trench.

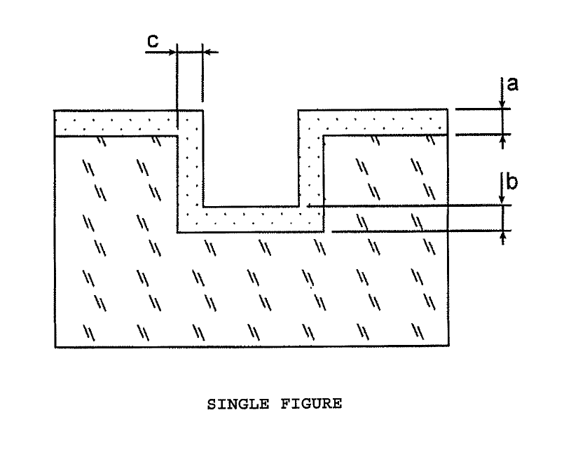

These dimensions a, b and c are represented on FIG. 1. The closer the conformity factors (b/a) and (b/c) are to 1, the more the conformity of the coating is considered as ideal.

Practically, in order to determine these conformity factors, the substrate is, firstly, cleaved after heat treatment along the desired observation line, then the coating/substrate interface is observed by scanning electron microscopy.

### Example 1

Described in this example is the experimental procedure for preparing a sol-gel solution that is a precursor of a lead zirconium titanate (PZT) ceramic, and also the process for depositing this solution, by dip coating, onto metallized silicon wafers, the surface of which has micron-scale features in relief, for the purpose of obtaining coatings that conform perfectly to the geometry of the substrate. The features used in this example are trenches having a depth of 1 μm, a width of 2 μm and spaced 2 μm apart.

### a) Preparation of the Sol-Gel Solution Having a Nominal PbZr_{0.52}Ti_{0.48}O₃ Composition

Firstly, a solution was prepared comprising a lead precursor. In order to do this, 751 g (1.98 mol) of lead acetate trihydrate and 330.2 g of ethylene glycol were weighed into a round-bottomed flask topped with a distillation assembly. The mixture was homogenized for 30 minutes at 70° C. so as to allow the lead acetate to completely dissolve. Then, the temperature of the homogenous solution was increased to dehydrate the lead precursor by distillation. During the distillation, the solution became yellow. The distillate recovered had a lead concentration of around 2.05 mol/kg.

225.1 g (0.792 mol) of titanium isopropoxide was stirred with 264 g of 1-propanol while flushing with argon and stirring. Still under the same conditions, 401.5 g (0.858 mol) of 70% zirconium propoxide in 1-propanol, then 458.7 g of ethylene glycol were added next. The mixture was left stirring for 20 minutes at ambient temperature.

Poured into a three-necked flask were 883 g (1.815 mol) of the previously prepared lead alkoxide solution, i.e. an excess of 10% to overcome the loss of lead oxide during the heat treatment. Under a stream of argon, the Ti/Zr solution was rapidly added into the three-necked flask with vigorous stirring (600 rpm). At the end of the addition, a condenser surmounted by a drying tube was fitted to the assembly. The mixture was refluxed for 2 hours (101° C.). After refluxing, the solution obtained had a concentration of around 26% as PZT mass equivalent.

The solution was then maintained at ambient temperature for its maturing phase. It was diluted after maturing for one week by addition of methanol, so as to obtain a solution having a concentration of 15% as PZT mass equivalent. The viscosity then obtained was around 3 mPa·s. The dilution made it possible to stabilize the viscosity of the solution for several months.

### b) Deposition of a Conformal Coating on the Substrate

The substrate was a silicon wafer having a diameter of 6 inches, covered by a layer of silica obtained by thermal oxidation. It was metallized by spraying with a layer of platinum having a thickness of around 100 nm. The surface of the wafer had trench-type features in relief, whose depth was 1 μm and width was of the order of one micron.

The previously prepared dilute solution was deposited by dip coating onto the wafer. More specifically, the wafer, the rear face of which had been protected by an adhesive film, was placed in the sol-gel solution for one minute, then removed at a withdrawal rate set between 2 and 10 cm/min. Once the wafer had been removed from the treatment bath, it was subjected to a heat treatment. This heat treatment comprised the following steps:
a first step known as a “pre-pyrolysis” step, consisting in heating the wafer on a hotplate for a duration ranging from 2 to 10 minutes at a temperature of 50° C., this step being intended to reduce the drying time compared to conventional drying at ambient temperature;
a pyrolysis step at a temperature of 360° C. for 5 to 10 minutes, this step being intended to eliminate the residues of organic compounds and to initiate the crystallization phase without trapping residues;
a relaxation step at a temperature of 390° C. for a duration ranging from 10 to 20 minutes intended to enable a release of the stresses generated during the shrinkage of the PZT film; and
a densification step at a temperature of 600° C. for a duration ranging from 5 to 10 minutes, intended to crystallize the film in a perovskite phase.

In order to characterize the conformity of the deposition at the surface of the wafer, the deposition/substrate interface was observed by scanning electron microscopy. In order to do this, the sample was cleaved after the heat treatment along the desired observation line.

The thickness of the coating was evaluated to be 90 nm with conformity factors (b/a) equal to 1.4 and (b/c) equal to 1.3.

### Example 2

Described in this example is the experimental procedure for preparing a sol-gel solution that is a precursor of a lead zirconium titanate (PZT) ceramic, and also the process for depositing this solution, by spin coating, onto metallized silicon wafers, the surface of which has micron-scale features in 3 dimensions, for the purpose of obtaining coatings that conform perfectly to the geometry of the substrate. The features used in this example are trenches having a depth of 1 μm, a width of 2 μm and spaced 2 μm apart.

### a) Preparation of the Sol-Gel Solution Having a Nominal PbZr_{0.52}Ti_{0.48}O₃ Composition

Firstly, a solution was prepared comprising a lead precursor. In order to do this, 751 g (1.98 mol) of lead acetate trihydrate and 330.2 g of ethylene glycol were weighed into a round-bottomed flask topped with a distillation assembly. The mixture was homogenized for 30 minutes at 70° C. so as to allow the lead acetate to completely dissolve. Then, the temperature of the homogenous solution was increased to dehydrate the lead precursor by distillation. During the distillation, the solution became yellow. The distillate recovered had a lead concentration of around 2.05 mol/kg.

225.1 g (0.792 mol) of titanium isopropoxide was stirred with 264 g of 1-propanol while flushing with argon and stirring. Still under the same conditions, 401.5 g (0.858 mol) of 7011 zirconium propoxide in 1-propanol, then 458.7 g of ethylene glycol were added next. The mixture was left stirring for 20 minutes at ambient temperature.

Poured into a three-necked flask were 883 g (1.815 mol) of the previously prepared lead alkoxide solution, i.e. an excess of 10% to overcome the loss of lead oxide during the heat treatment. Under a stream of argon, the Ti/Zr solution was rapidly added into the three-necked flask with vigorous stirring (600 rpm). At the end of the addition, a condenser surmounted by a drying tube was fitted to the assembly. The mixture was refluxed for 2 hours (101° C.). After refluxing, the solution obtained had a concentration of around 26% as PZT mass equivalent.

The solution was then maintained at ambient temperature for its maturing phase. It was diluted after maturing for one week by addition of ethylene glycol, so as to obtain a solution having a concentration of 10% as PZT mass equivalent. The viscosity then obtained was around 25 mPa·s. The dilution made it possible to stabilize the viscosity of the solution for several months.

### b) Deposition of a Conformal Coating on the Substrate

The substrate was a silicon wafer having a diameter of 6 inches, covered by a layer of silica obtained by thermal oxidation. It was metallized by spraying with a layer of platinum having a thickness of around 100 nm. The surface of the wafer had trench-type features in relief, whose depth was 1 μm and width was of the order of one micron.

The previously prepared dilute solution was filtered to 0.2 μm and was deposited by spin coating onto the wafer. The speed of rotation was set at 4500 rpm. After depositing, the layer underwent the following heat treatment:
a first step known as a “pre-pyrolysis” step, consisting in heating the wafer on a hotplate for a duration ranging from 2 to 10 minutes at a temperature of 50° C., this step being intended to reduce the drying time compared to conventional drying at ambient temperature;
a pyrolysis step at a temperature of 360° C. for 5 to 10 minutes, this step being intended to eliminate the residues of organic compounds and to initiate the crystallization phase without trapping residues.

The deposition followed by a heat treatment such as mentioned above was repeated 6 times.

The wafer coated with 6 layers underwent a final heat treatment comprising:
a relaxation step at a temperature of 390° C. for a duration ranging from 10 to 20 minutes, this step being intended to enable a release of the stresses generated during the shrinkage of the PZT film; and
a densification step at a temperature of 600° C. for 5 to 10 minutes, intended to crystallize the film in a perovskite phase.

In order to characterize the conformity of the deposition at the surface of the wafer, the deposition/substrate interface was observed by scanning electron microscopy. In order to do this, the sample was cleaved after the heat treatment along the desired observation line.

The thickness of the coating was evaluated to be 90 nm with conformity factors (b/a) equal to 1.4 and (b/c) equal to 1.3.

1-23. (canceled)

24. A process for producing a coating made of an oxide ceramic that conforms to geometry of a substrate having features in relief, the process comprising:
depositing on said substrate a layer of a sol-gel solution that is a precursor of said ceramic;
heat treating said layer thereby converting it to said ceramic;
said depositing and heat treating steps optionally repeated one or more times, wherein the sol-gel solution that is a precursor of said ceramic is prepared by a process successively comprising the following steps:
a) preparing a first solution by bringing molecular precursor or precursors of the metals and/or metalloids intended to be incorporated into the composition of the ceramic into contact with a medium comprising a solvent that includes at least two —OH functional groups and optionally an aliphatic monoalcohol;
b) leaving the first solution to stand for a sufficient time needed to obtain a second solution that has a substantially constant viscosity;
c) diluting the second solution to a predetermined amount with a solvent identical to that from step a) or a solvent that is miscible with the solvent used in step a) but different from it.

25. The process according to claim 24, wherein the oxide ceramic is chosen from the group consisting of lead zirconium titanate (known by the abbreviation PZT), barium titanate, barium strontium titanate (known by the abbreviation BST), lead zinc niobium titanate (known by the abbreviation PZNT), lead zinc niobate (known by the abbreviation PZN), lead magnesium niobate (known by the abbreviation PMN), lead titanate (known by the abbreviation PT), potassium calcium niobate, bismuth potassium titanate (known by the abbreviation BKT), strontium bismuth titanate (known by the abbreviation SBT), potassium tantalate (known by the abbreviation KLT) and solid solutions of PMN and PT.

26. The process according to claim 24, wherein the oxide ceramic is chosen from the group consisting of SiO₂, HfO₂, ZrO₂, Al₂O₃, and Ta₂O₅.

27. The process according to claim 24, wherein the metal or metalloid molecular precursor is an inorganic metal or metalloid salt.

28. The process according to claim 24, wherein the metal or metalloid molecular precursor is an organometallic metal or metalloid compound.

29. The process according to claim 28, wherein the organometallic metal or metalloid compound is an alkoxide corresponding to the formula (RO)ₙM, wherein M denotes the metal or metalloid, n represents the number of ligands linked to M, this number also corresponding to the valency of M, and R represents a linear or branched alkyl group which may comprise from 1 to 10 carbon atoms or an aromatic group comprising from 4 to 14 carbon atoms.

30. The process according to claim 28, wherein the organometallic metal or metalloid compound is an organometallic compound of formula:
X_{y}R¹_{z}M
wherein:
M represents a metal or a metalloid;
X represents a hydrolysable group chosen from halogen, acrylate, acetoxy, acyl or OR′ groups, with R′ representing a linear or branched alkyl group which may comprise from 1 to 10 carbon atoms or an aromatic group which may comprise from 4 to 14 carbon atoms;
R¹ represents a non-hydrolysable group chosen from optionally perfluorinated linear or branched alkyl groups which may comprise from 1 to 10 carbon atoms, or aromatic groups which may comprise from 4 to 14 carbon atoms; and
y and z are integers chosen so that y+z is equal to the valency of M.

31. The process according to claim 24, wherein the first solution further comprises one or more polymerizable compounds, such as ethylenic monomers.

32. The process according to claim 24, wherein the solvent comprising at least two —OH functional groups used in step a) and optionally step c) is an alkylene glycol that has a number of carbon atoms ranging from 2 to 5.

33. The process according to claim 24, wherein the optional aliphatic monoalcohol from step a) comprises from 1 to 6 carbon atoms.

34. The process according to claim 24, wherein the sol-gel solution prepared in step a) is left to stand, in the context of step b), for a duration ranging from 1 week to 4 months.

35. The process according to claim 24, wherein depositing is carried out by dip coating or by spin coating.

36. The process according to claim 35, wherein, when depositing is carried out by spin coating, the dilution solvent used in step c) is a solvent comprising at least two —OH functional groups, identical or different to that used in the context of step a).

37. The process according to claim 35, wherein, when depositing is carried out by dip coating, the dilution solvent used in step c) is a solvent having a lower viscosity than that of the solvent comprising at least two —OH functional groups that is used in step a).

38. The process according to claim 37, wherein the dilution solvent is an aliphatic monoalcohol comprising from 1 to 6 carbon atoms.

39. The process according to claim 24, wherein the ceramic oxide is lead zirconium titanate (PZT).

40. The process according to claim 24, wherein heat treating comprises:
drying the deposited layer(s) so as to gel the layer(s);
optionally, pyrolyzing the deposited layer(s) to eliminate organic compounds from the layer(s);
optionally, relaxing the deposited layer(s) to eliminate stresses generated during shrinkage of the layer(s); and
optionally, densifying the deposited layer(s).

41. The process according to claim 40, wherein the drying step is carried out at ambient temperature for a duration ranging from 1 to 10 minutes.

42. The process according to claim 40, wherein the pyrolyzing step is carried out at a temperature ranging from around 300° C. to around 400° C. and for a duration ranging from around 5 minutes to 10 minutes.

43. The process according to claim 42, wherein the relaxing step is carried out at a temperature 10° C. to 30° C. above the pyrolyzing temperature for a duration which may range from 10 to 30 minutes.

44. The process according to claim 40, wherein the densifying step is carried out at a temperature ranging from 500° C. to 800° C. for a duration ranging from 1 minute to 10 minutes.

45. The process according to claim 24, wherein the coating has a thickness ranging from 30 to 200 nm.

46. The process according to claim 24, wherein the substrate has features of micron-scale size.
